(19) United States
(12) Patent Application Publication
(10) Pub. No.: US 2016/0227631 A1
(43) Pub. Date: Aug. 4, 2016

(54) Wirelessly-Controlled LED Lighting Device

(71) Applicants: William Harold Weedon, III, Warwick, RI (US); Sean Kyle Aguiar, North Kingstown, RI (US); John Albert Phillips, II, Warwick, RI (US); Thomas Nicholas Walsh, III, North Kingstown, RI (US); Zachary Thomas White, Kingston, RI (US)

(72) Inventors: William Harold Weedon, III, Warwick, RI (US); Sean Kyle Aguiar, North Kingstown, RI (US); John Albert Phillips, II, Warwick, RI (US); Thomas Nicholas Walsh, III, North Kingstown, RI (US); Zachary Thomas White, Kingston, RI (US)

(73) Assignees: Applied Radar, Inc., North Kingstown, RI (US); Quonset Technology, LLC, North Kingstown, RI (US)

(21) Appl. No.: 14/610,741

(22) Filed: Jan. 30, 2015

(51) Int. Cl. H05B 37/02; F21V 29/70; H05B 33/08; H04W 88/16; H04W 84/18

(52) U.S. Cl. CPC H05B 37/0272; H04W 88/16; H04W 84/18; H05B 33/0806; F21V 29/70

(57) ABSTRACT

A wirelessly controlled LED lighting system comprising: an LED lighting device further comprised of an LED circuit board with one or more light-emitting diode (LED) chips and an antenna attached to said LED circuit board; an LED drive current source; a wireless radio controller attached to said LED Drive current source; associated packaging, heat-sink and optics; embedded software; and a wireless internet gateway system further comprised of a gateway system device, a control device and application software.

### FEDERALLY SPONSORED RESEARCH

N/A

### FIELD OF THE INVENTION

This invention relates to methods of constructing LED lighting devices that are controlled by wireless RF radio signals, which enables dimming and on/off control of the wireless bulbs through wireless control from a device such as a smart phone or tablet computer.

### BACKGROUND OF THE INVENTION

LED light bulbs are gaining increased popularity and replacing the function of traditional incandescent and halogen bulbs due to their energy efficiency and fire safety compared to halogen and incandescent bulbs. One example is the LED replacement for the so-called “multi-faceted reflector” (MR16) bulb that traditionally contained a pressurized halogen bulb that operated up to 200 deg C. This bulb has been used in track lighting, recessed ceiling lighting, pendant fixtures, landscape lighting, and retail display lighting. The LED replacement typically uses optics instead of the multi-faceted reflector to obtain the desired directional lighting capability, in a much more energy efficient and safer package.

Adding wireless control to the LED bulb allows smart dimming and on/off control of individual bulbs without requiring additional control wiring infrastructure. This saves cost of the wiring and control infrastructure and allows existing installations to be upgraded to wireless control. The wireless control or “smart bulb” capability allows additional energy savings because it allows the bulbs to be programmed to turn off or dim down easily at preset times. It can also be programmed to turn on only when someone walks in the room, by adding additional motion sensors to the network. These smart bulb features are useful and desirable in both commercial and home settings. Additionally, the wireless bulb may be used in outdoor landscape light fixtures as well as interior lighting.

Using the invention technique, a microprocessor-enabled radio chip is embedded in each wireless light bulb and forms an ad-hoc network from bulb-to-bulb. The bulb network also connects to a wireless gateway, which allows wireless connection to a control device such as a smart phone or tablet computer, or to any other device that is connected to the internet.

One type of lighting fixture that is of particular interest is the LED replacement for the MR16 bulb (or the similar GU10 bulb that operates off of 120V line voltage as opposed to a much lower voltage). This is a particularly challenging bulb to include wireless control due to the limited space available for the wireless radio, processor and antenna. A further challenge of including wireless control in the MR16 bulb is the incorporation of an antenna with minimal blockage of the RF signal by the lighting fixture, which impacts the range of the wireless system. This invention discloses a practical and cost-effective technique for embedding a wireless radio/processor and antenna in small bulb such as the MR16 (or GU10) in such a way that RF blockage is minimized and the range of the wireless signal is maximized. It also discloses a method of integrating the wireless radio/processor with the LED driver electronics.

The invention is applicable but not limited to the MR16 bulb. For example, the GU10 bulb is similar to the MR16 bulb, but operates off of a typical 120 Volt line voltage, whereas the MR16 operates off of a much lower voltage (typically 12 or Volts). The GU10 is a slightly larger but similar form-factor to the MR16, and this invention applies equally to the MR16 and GU10, as well as other LED light bulbs that include wireless control.

This invention is related to that disclosed in WO2013103698A1 with several notable differences and improvements. We have eliminated the coaxial cable connection between the antenna and RF radio in the preferred embodiment of WO2013103698A1, a modification that greatly reduces cost and simplifies manufacturing. In the new invention we have made the wireless LED lighting device practical and cost-effective, integrating the wireless radio controller with the LED drive current source on the same printed circuit-board. We also make use of a commercially-available chip antenna in one of the preferred embodiments, which requires only a single antenna lead connection between the wireless radio/current source board and the LED/antenna board.

The invention described in EP2706818A2 describes an LED bulb with a threaded base portion comprising a bulb with a much larger form-factor than that described in the present invention. Moreover, EP2706818A2 does not describe the antenna used to control the bulb, and provides no mechanism for ensuring reliable communication to/from the bulb and preventing blockage of the RF signals when placed inside a metallic lighting enclosure.

Similarly, U.S. Pat. No. 6,759,966B1 describes a remote control bulb device (not necessarily LED), but does not provide details of the antenna, including blockage mitigation, and does not discuss integration of an LED current driver with a wireless radio.

The invention disclosed US20140203939A1 discusses the control and monitoring of LED bulbs by wireless radio or other means. However, the invention discusses the LED replacement of a conventional screw-in lightbulb socket, and does not discuss reduced form-factor bulbs including the MR16 and GU10, and does not discuss the wireless antenna including blockage mitigation.

The invention disclosed in US20140273892A1 discloses a wireless light bulb that uses a metallic heat sink as its antenna, which is significantly different that the invention disclosed herein.

### OBJECTS OF THE INVENTION

It is therefore an object of this invention to disclose methods of manufacturing small-sized LED light bulbs that incorporate control by means of wireless RF radio signals.

It is a further object of this invention to provide a method of controlling indoor or outdoor lighting fixtures using wireless control in existing installations.

It is a further object of this invention to reduce energy costs by providing a convenient means of controlling the dimming and on/off state of interior and exterior lighting. The wireless control can be provided through a device such as a smart phone or tablet, or any computer device connected to the internet. The lighting can be pre-programmed to dim at certain times and time-adjusted for seasons. Alternately, the lighting control may be event-driven, for example by utilizing external wireless motion sensors to trigger the light state. The lighting can also be controlled remotely through the internet, for example if someone forgets to turn off the lights when they go on vacation.

It is a further object of this invention to extend the range at which the wireless LED ad-hoc network operates, which allows the wireless LED bulbs to be spaced further apart and be located in various rooms inside a building.

It is a further object of this invention to reduce the cost of the LED bulb by integrating the wireless radio/processor on the same circuit board as the LED current driver.

It is a further object of this invention to reduce the cost of the LED bulb by integrating the antenna with the LED package and eliminating hand-labor manufacturing and external wire antennas.

It is a further object of this invention to add security to the wireless LED network so that it cannot be easily “hacked” by an intruder.

This invention is brought about by the realization that small sized LED lights can be controlled wirelessly, can be integrated in a wireless network and can be controlled via the internet, thus providing a low cost retrofit for existing wired LED or halogen bulb systems.

### BRIEF DESCRIPTION OF THE DRAWINGS

FIG. 1 is a depiction of the LED lighting device with the attached controller and antenna.

FIG. 2 is a depiction of how the lighting device would operate in a network and be controlled via the internet.

### DETAILED DESCRIPTION OF THE PREFERRED EMBODIMENTS

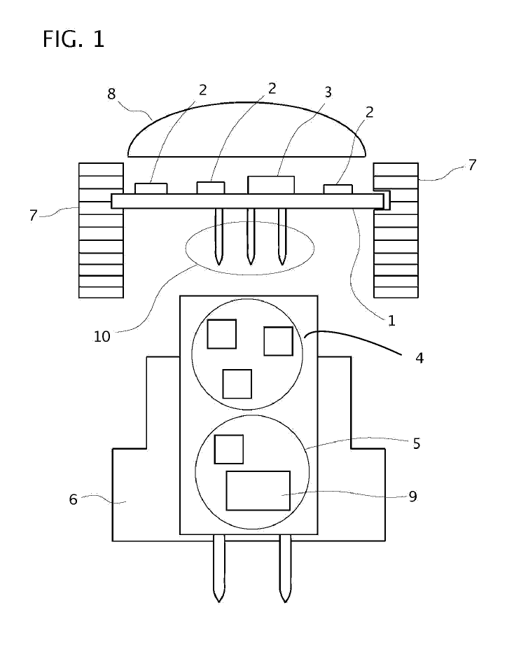

FIG. 1 shows the LED circuit board 1, with the embedded LED chips 2, with the antenna attached 3. The LED drive current source 4, is also depicted with the wireless radio controller 5, and embedded software 9. The LED current source 4 is connected to the LED circuit board via an attachment device 10. The device is finished with Packaging 6, a heat sink 7, and optics 8.

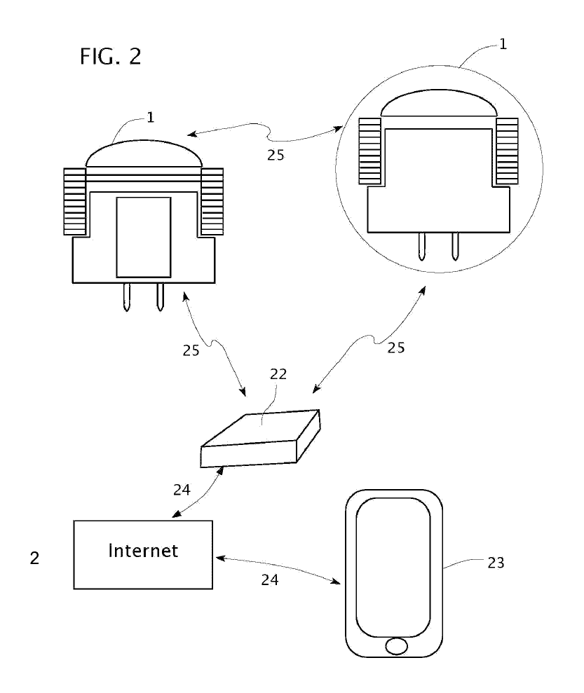

FIG. 2 shows the complete LED lighting device 1, the wireless internet gateway device 22, a control device 23, wireless internet connections 24, to the internet 2 from the gateway device 22 and the control device 23. The gateway device communicates via a separate wireless pathway 25, to the LED lighting devices 1.

PATENT CITATIONS

| | Filing | Publication | | |
|---|---|---|---|---|
| Cited Patent | Date | Date | Applicant | Title |
| WO2013103698A1 | Jan. 6, | Jul. 11, | Sagal, E | Led lamps with |
| | 2012 | 2013 | Mikhail and | enhanced |
| | | | Arnold, Gary | wireless |
| | | | R | communication |
| EP2706818A2 | Sep. 7, | Mar. 12, | Chen, Chun- | Wirelessly |
| | 2012 | 2014 | Chen and Ku, | controllable |
| | | | Hsiao-Tung | LED bulb and |
| | | | | wireless |
| | | | | control method |
| | | | | thereof |
| U.S. Pat. No. | Sep. 1, | Jul. 6, | Weng, | Wireless |
| 6,759,966B1 | 2000 | 2004 | Linsong | remote control |
| | | | | bulb device |
| US20140203939A1 | Jan. 21, | Jul. 24, | Harrington, | Control and |
| | 2013 | 2014 | Richard H | monitoring of |
| | | | and Krapf, | light-emitting |
| | | | Charles W | diode (led) |
| | | | | bulbs |
| US20140273892A1 | Mar. 14, | Sep. 18, | Nourbakhsh, | Integrated |
| | 2013 | 2014 | Farhad | networking |
| | | | | equipment and |
| | | | | diversity |
| | | | | antenna in |
| | | | | light bulb |

What is claimed is:

1. A wirelessly controlled LED bulb-based lighting system comprising:
an LED lighting device further comprised of an LED circuit board with one or more light-emitting diode (LED) chips and an antenna attached to said LED circuit board; an LED drive current source; a wireless radio controller attached to said LED drive current source; associated packaging, heat-sink and optics; embedded software;
and a wireless internet gateway system further comprised of a gateway system device, a control device and application software.

2. The LED drive current source as described in claim 1 wherein said attached wireless radio controller comprises one or more electronic chips containing a microcontroller and a wireless radio.

3. The microcontroller of claim 2 wherein said microcontroller is a microprocessor chip.

4. The microcontroller of claim 2 wherein said microcontroller is a field-programmable gate array (FPGA).

5. The LED drive current source of claim 2 wherein the microcontroller and wireless radio are integrated into a single electronic computer chip.

6. The LED drive current source of claim 2 wherein said attached wireless radio is attached to a radio frequency (RF) amplifier chip.

7. The RF amplifier chip of claim 6 wherein said amplifier chip contains one or more RF transmit/receive switches.

8. The RF amplifier chip of claim 6 wherein said amplifier chip contains an RF antenna switch to connect to at least one external antenna.

9. The wireless radio of claim 2 wherein said wireless radio transmits and receives using IEEE 802.15.4 format.

10. The LED circuit board of claim 1 wherein said antenna attached to said LED circuit board comprises a surface-mount antenna device.

11. The surface-mount antenna device of claim 10 wherein said surface mounted device is an antenna chip.

12. The surface-mount antenna device of claim 10 wherein said surface mounted antenna device is comprised of a post with spiral metallic windings.

13. The LED circuit board of claim 1 wherein said antenna attached to said LED circuit board is comprised of an etched microstrip circuit.

14. The etched microstrip circuit of claim 13 wherein said microstrip circuit is comprised of a loop or dipole antenna.

15. The etched microstrip circuit of claim 13 wherein said etched microstrip circuit is comprised of a microstrip patch antenna.

16. The LED circuit board of claim 1 that is attached to said LED current source of claim 1 wherein said attachment is achieved by the use of a multi-pin connector.

17. The LED circuit board of claim 1 that is attached said LED current source of claim 1 wherein said attachment is achieved by the use of spring-loaded or pressure-contact pins.

18. The LED drive current source of claim 1 wherein said LED Drive current source is attached at a right angle to said LED circuit board of claim 1.

19. The LED drive current source of claim 1 wherein said LED drive current source is mounted parallel to said LED circuit board of claim 1.

20. The LED drive current source of claim 1 wherein said LED drive current source is combined with said LED circuit board of claim 1 to form one circuit board.

21. The LED lighting device of claim 1 wherein said LED lighting device is packaged in an industry-standard multi-faceted reflector MR16 or GU10 form-factor.

22. The embedded software of claim 1 wherein said embedded software allows said wireless radio of claim 2 to communicate using ZigBee format.

23. The embedded software of claim 1 wherein said embedded software allows said wireless radio of claim 2 to communicate using JenNet-IP format.

24. The external wireless gateway device of claim 1 wherein said external wireless gateway communicates with said LED lighting device of claim 1 through said wireless radio of claim 2.

25. The control device of claim 1 wherein said control device communicates with said LED lighting device through said wireless gateway of claim 24.

26. The control device of claim 25 wherein said control device is comprised of a smart phone.

27. The control device of claim 25 wherein said control device is comprised of a computer tablet.

28. The external wireless gateway device of claim 24 wherein said external wireless gateway is comprised of an interface to the internet (wired or wireless such as IEEE 802.11) and a local interface (such as IEEE 802.15.4) to the LED lighting device.

29. The application software implemented on the control device of claim 25 wherein said application software allows power on/off control and dimming of said LED lighting device of claim 1.

30. The application software of claim 29 wherein said application software is implemented using the Android® operating system.

31. The application software of claim 29 wherein said application software is implemented in IOS for Apple® iPhone® and iPad® compatible smart phone and tablet products.

32. The wireless radio of claim 2 wherein said wireless radio forms an ad-hoc network with other nearby bulbs that are configured to operate together.
